(19) United States
(12) Patent Application Publication
(10) Pub. No.: US 2002/0160199 A1
(43) Pub. Date: Oct. 31, 2002

(54) Protective covering with a two-layer coating buil-up

(76) Inventors: Steffen Hofacker, Butzbach (DE); Markus Mechtel, Koln (DE)

Correspondence Address: BAYER CORPORATION, PATENT DEPARTMENT, 100 BAYER ROAD, PITTSBURGH, PA, 15205, US

(21) Appl. No.: 10/054,558

(22) Filed: Jan. 22, 2002

(30) Foreign Application Priority Data
Jan. 24, 2001 (DE) 10103026.6

(51) Int. Cl. B32B 27/40; B32B 27/36

(52) U.S. Cl. 428/412; 428/424.4; 428/424.6

(57) ABSTRACT

The invention relates to protective coverings with a coating build-up of at least two layers, the first coating comprising an adhesion promoter based on a two-component polyurethane binder containing alkoxysilyl groups and the second coating comprising an inorganic coating, a process for the production of these protective coverings and the covered substrates.

### BACKGROUND OF THE INVENTION

The invention relates to protective coverings with a coating build-up of at least two layers, the first coating containing an adhesion promoter based on a two-component polyurethane binder containing alkoxysilyl groups and the second coating containing an inorganic coating, a process for the production of these protective coverings and covered substrates.

Polymeric substrates are extremely diverse materials with a number of desirable properties. However, a disadvantage of these materials is, for example, their sensitivity towards mechanical damage on the surface or towards chemicals, such as solvents.

A method of protecting the surface of polymeric substrates and in particular plastics against such damage comprises application of a suitable coating to the substrate of plastic. The composition of the coating primarily depends on whether the surface is to be protected rather from mechanical damage, radiation, the action of chemicals or other environmental influences (e.g. contamination etc.). Transparent plastics, such as e.g. polycarbonate, are particularly sensitive to mechanical damage on the surface. Numerous coating materials which effectively protect polycarbonates in particular from mechanical damage are therefore known. These are substantially organically modified inorganic coatings, which usually cure by condensation or by means of UV. Examples are found in J. Sol-Gel Sci. Techn. 1998, 11, 153-159, Abstr. 23rd Annual Conference in Organic Coatings, 1997, 271-279, EP-A 0 263 428, DE-A 29 14 427 and DE-A 43 38 361.

However, application of these inorganic coatings is often associated with the problem that the adhesion between the plastic and coating is inadequate. A number of methods to obtain an adequate adhesion are already described in the prior art. Physical methods which may be mentioned are, for example, plasma or corona treatment, and a possible chemical method is e.g. the use of an adhesion promoter (primer).

Multi-layer coating build-ups are described, for example, in EP-A 0947520 (example 12) and in WO 98/46692 (examples A and B) or in Surface and Coatings Technology, 1999, 112, 351-357.

Many adhesion promoters react both with the surface of the plastic and with the coating, and (covalent) chemical bonds are formed. In the case of polycarbonates as the substrate e.g. aminosilanes, such as aminopropyltrialkoxysilanes (DE-A 19 858 998), are employed. The amino group reacts here with the polycarbonate surface and the alkoxysilyl radicals react with the organically modified, silicon-containing inorganic coating. However, these N—H-functional adhesion promoters have the disadvantage that the polycarbonate is damaged considerably by the basic nitrogen function, which manifests itself e.g. optically by a significant yellow coloration. Another disadvantage is that the adhesion of the inorganic coating is rapidly reduced on storage in water, in particular hot water. The film becomes cloudy, for example, blistering occurs and, finally, the film can be completely detached.

An object of the present invention is to provide protective coverings, in particular for polymeric substrates, in order to protect them from mechanical damage and/or environmental influences, such as, for example, UV light or contamination, which do not have the above mentioned disadvantages, e.g. optical impairment or an inadequate stability to weathering.

It has now been found that protective coverings can effectively protect substrates, if they have a first coating containing a two-component polyurethane adhesion promoter having alkoxysilyl groups and a second coating containing, for example, an inorganic coating. In particular polymeric substrates can be protected from mechanical damage and/or radiation damage and/or contamination.

### SUMMARY OF THE INVENTION

The invention relates to a protective covering containing at least a two-layer coating build-up wherein the first coating comprises a two-component polyurethane adhesion promoter (primer) containing alkoxysilyl groups and the second coating comprises an inorganic or organic coating or an inorganic-organic hybrid coating.

### DETAILED DESCRIPTION OF THE INVENTION

As the first layer of the protective covering according to the invention, two-component polyurethane adhesion promoters containing

I)

a hardener component (A), comprising an addition product of at least one organic polyisocyanate (B) with an average NCO functionality of 2.5 to 5.0 and an isocyanate content of 8 to 27 wt. % and

an alkoxysilane (C) with at least one group which is reactive towards isocyanate groups, of formula (I)

Q—Z—SIXₐY₃₋ₐ (I),

in which

Q represents an isocyanate-reactive group, preferably OH, SH or NHR₁, wherein R₁ represents a C₁-C₁₂-alkyl group or C₆-C₂₀-aryl group or represents —Z—SiXₐY₃₋ₐ,

Z represents a linear or branched C₁-C₁₂-alkylene group, preferably a linear or branched C₁-C₄-alkylene group,

X represents a hydrolyzable group, preferably C₁-C₄-alkoxy,

Y represents identical or different C₁-C₄-alkyl groups and

a represents an integer from 1 to 3,

and

II) a paint resin (D) which is reactive towards isocyanate groups, are suitable.

The ratio of groups of the paint resin (D) which are reactive towards isocyanate groups to the isocyanate groups of the hardener (A) is between 0.5:1 to 2:1, preferably between 0.7:1 to 1.3:1.

The polyisocyanate (B) contained in the hardener component (A) preferably has an average NCO functionality of 2.3 to 4.5, and preferably an isocyanate group content of 11.0 to 24.0 wt. %. The content of monomeric diisocyanates is less than 1 wt. %, preferably less than 0.5 wt. %.

The polyisocyanate (B) contains at least one organic polyisocyanate with aliphatically, cycloaliphatically, araliphatically and/or aromatically bonded isocyanate groups.

The polyisocyanate or polyisocyanate mixtures (B) are any desired polyisocyanates which are prepared by modification of simple aliphatic, cycloaliphatic, araliphatic and/or aromatic diisocyanates, are built up from at least two diisocyanates and have a uretdione, isocyanurate, allophanate, biuret, iminooxadiazinedione and/or oxadiazinetrione structure, such as are described by way of example, for example, in J. Prakt. Chem. 336 (1994) 185-200 and in DE-A 16 70 666, DE-A 19 54 093, DE-A 24 14 413, DE-A 24 52 532, DE-A 26 41 380, DE-A 37 00 209, DE-A 39 00 053 and DE-A 39 28 503 or in EP-A 336 205, EP-A 339 396 and EP-A 798 299.

Suitable diisocyanates for the preparation of such polyisocyanates are diisocyanates of the molecular weight range from 140 to 400 which are accessible by phosgenation or by phosgene-free processes, for example by thermal urethane cleavage, and have aliphatically, cycloaliphatically, araliphatically and/or aromatically bonded isocyanate groups. Examples include 1,4-diisocyanatobutane, 1,6-diisocyanatohexane (HDI), 2-methyl-1,5-diisocyanatopentane, 1 ,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis-(isocyanatomethyl)-cyclohexane, 1-isocyanato-3,3,5-trimethyl-5-isocyanatomethylcyclohexane (isophorone-diisocyanate, IPDI), 4,4′-diisocyanatod icyclohexylmethane, 1-isocyanato-1-methyl-4(3)isocyanato-methyl-cyclohexane, bis-(isocyanatomethyl)-norbornane, 1,3- and 1,4-bis-(1-isocyanato-1-methylethyl)-benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixture of such diisocyanates.

The starting components (B) are preferably polyisocyanates or polyisocyanate mixtures with exclusively aliphatically and/or cycloaliphatically bonded isocyanate groups.

More preferred starting components (B) are polyisocyanates or polyisocyanate mixtures which have a biuret or isocyanurate structure and are based on HDI, IPDI and/or 4,4′-diisocyanatodicyclohexylmethane.

Suitable alkoxysilanes (C) with isocyanate-reactive groups include, for example, hydroxymethyltri(m)ethoxysilane and alkoxysilyl compounds with secondary amino groups or mercapto groups. Examples of secondary aminoalkoxysilanes include N-methyl-3-aminopropyl-tri(m)ethoxysilane, N-phenyl-3-aminopropyltrimethoxysilane, bis-(gamma-trimethoxysilylpropyl)amine, N-butyl-3-aminopropyltri(m)ethoxysilane, N-ethyl-3-aminoisobutyltri(m)ethoxysilane or N-ethyl-3-aminoisobutyl-methyldi(m)ethoxysilane and the analogous C₂-C₄-alkoxysilanes.

Other suitable alkoxysilanes (C) include amino-functional alkoxysilyl compounds which are obtained according to U.S. Pat. No. 5,364,955 by reaction of aminosilanes of the above mentioned general formula (I), in which R₁=H, with maleic or fumaric acid esters of the general formula (II)

R₂OOC—CH═CH—COOR₃ (II),

in which

R₂ and R₃ represent identical or different (cyclo)-alkyl radicals having 1 to 8 carbon atoms.

Preferred compounds of the general formula (II) are dimethyl maleate and diethyl maleate.

Further examples of alkoxysilanes (C) are 3-mercaptopropyl-trimethoxysilane and 3-mercaptopropyltriethoxysilane. Preferred alkoxysilanes (C) are N-butyl-3-aminopropyl-tri(m)ethoxysilane and 3-mercapto-propyltri(m)ethoxysilane.

Mixtures of the alkoxysilanes (C) of formula (I) can also be employed for the preparation of the hardener (A). For example, mixtures of alkoxysilanes (C) which contain the same isocyanate-reactive group Q but different hydrolyzable groups X are possible. Mixtures which contain alkoxysilanes (C) of formula (I) with different functional groups Q are also suitable.

The modification of polyisocyanate component (B) with alkoxysilanes (C) is carried out in a molar NCO/Q ratio of 1:0.01 to 0.75, preferably in a molar NCO/Q ratio of 1:0.05 to 0.4.

In principle, it is of course also possible to react polyisocyanates in a higher molar ratio or even completely, i.e. correspondingly up to an NCO/Q ratio of 1:1, with the amino-functional alkoxysilyl compounds (Q—NH).

Suitable paint resins (D) which are reactive towards isocyanate groups are polyhydroxy compounds, such as tri- and/or tetrafunctional alcohols and/or the conventional polyether polyols, polyester polyols, polycarbonate polyols and/or polyacrylate polyols.

Paint binders or paint binder components with isocyanate-reactive groups other than hydroxyl groups are also suitable as paint resin (D). These include, for example, polyurethanes or polyureas, which can be crosslinked with polyisocyanates on the basis of the active hydrogen atoms present in the urethane or urea groups. Suitable reaction partners (D) also include polyamines, having blocked amino groups, such as polyketimines, polyaldimines or oxazolanes, from which free amino groups and, in the case of oxazolanes, free hydroxyl groups are formed under the influence of moisture. These groups are able to react with the polyisocyanate mixtures. Preferred paint resins (D) are polyacrylate polyols and polyester polyols.

The polyisocyanate and/or binder components are in general employed in the two-component (2K) PU binder in a form diluted with solvents. These solvents include for example butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethylsulfoxide or any desired mixtures of such solvents. Preferred solvents are butyl acetate, ethyl acetate and diacetone alcohol.

The conventional auxiliary substances in coating technology can optionally be added as further components to the solvent-containing 2-C PU binder. Conventional auxiliary substances are all the additives known for the preparation of lacquers and paints. They include inorganic or organic pigments, light stabilizers, dispersing agents, flow control agents, thickeners, defoamers, adhesives, fungicides, bactericides, stabilizers, inhibitors or catalysts. It is of course also possible to add several of the auxiliary substances.

The second coating of the protective covering according to the invention contains an inorganic or organic coating or an inorganic-organic hybrid coating.

Suitable inorganic coatings include purely inorganic paint systems or also organically modified inorganic paint systems or also layers deposited via a plasma process (e.g. Al₂O₃, TiO₂, SiO₃, TiC).

Purely inorganic paint systems are to be understood as coatings which are produced via the sol-gel process and are built up from monomer units which carry no organic groups which, if present and with an ideal network build-up, could remain as constituents in the network.

Such monomer units include tetraalkoxysilanes, such as tetra(m)ethoxysilane, or also metal alkoxides, such as aluminium, titanium or zirconium alkoxide.

Such inorganic paint systems can also contain inorganic filler particles, such as e.g. SiO₂, Al₂O₃ or AlOOH.

Organically modified inorganic paint systems are to be understood e.g. as meaning those coatings produced by the sol-gel process which are built up from monomer units which carry organic groups which remain as constituents in the network which forms. These organic groups can be functional or non-functional.

Examples of monomer units with non-functional organic groups include alkylalkoxysilanes, such as methyltri(m)ethoxysilane, arylalkoxysilanes, such as phenyltri(m)ethoxysilane, or also carbosilane compounds, such as are described e.g. in U.S. Pat. Nos. 5,679,755, 5,677,410, 6,005,131, 5,880,305 or in EP-A 947520.

Examples of monomer units with functional organic groups include alkoxysilanes containing vinyl, acryl or also methacryl groups, such as vinyltri(m)ethoxysilane, acryloxypropyltri(m)ethoxysilane or methacryloxypropyltri(m)ethoxysilane, and epoxy-functional alkoxysilanes, such as glycidyloxypropyltri(m)ethoxysilane, or also NCO-functional alkoxysilanes, such as 3-isocyanatopropyltri(m)ethoxysilane.

With some of the monomer units with functional groups it is possible to build up a crosslinked organic polymer system alongside the inorganic network which exists or forms.

However, functional organic groups include those which do not necessarily serve to build up an organic crosslinking, such as halogens, acid, alcohol or thiol groups.

Suitable organic coatings include polyurethanes, melamine crosslinking systems or also alkyd resin paint systems.

A generally known process for the preparation of inorganic sol-gel paints is the sol-gel process such as is described in detail by C. J. Brinker and W. Scherer in “Sol-Gel Science: The Physics and Chemistry of Sol-Gel Processing, Academic Press, New York (1990). Sol-gel paints with a high mechanical resistance such as are described, for example, in U.S. Pat. Nos. 4,624,870, 3,986,997, 4,027,073, EP-A 358 011, U.S. Pat. No. 4,324,712, WO 98/52992 or in WO 94/06 807, are also suitable.

Inorganic-organic hybrid coatings are distinguished in that they have both an organic polymer system and an inorganic polymer system. These can be obtained by combination of inorganic and organic coatings and can be present side by side or in linked form. Possible inorganic-organic hybrid coatings are, for example, those in which an organic polymer matrix is modified by addition or incorporation of inorganic units. Inorganic units include silica sol dispersions in water or in organic solvents and/or hydrolysates of (organofunctional) alkoxysilanes.

Important properties of the protective covering, such as scratch and abrasion resistance, radiation protection and hydrophobicity and/or oleophobicity, are determined via the chemical composition of the particular coating.

Inorganic coatings or inorganic-organic hybrid coatings are preferred. Coatings which are particularly preferred are organically modified inorganic coatings, for example, paint binders which crosslink via condensation and contain at least one multifunctional cyclic carbosiloxane of the general formula (III)

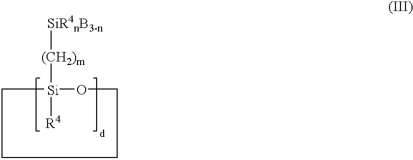

in which

R⁴ represents a C₁-C₁₈-alkyl group and/or a C₆-C₂₀-aryl group, wherein R⁴ can be identical or non-identical within the molecule,

B represents a radical chosen from the group consisting of OH, C₁-C₄-alkoxy, C₆-C₂₀-aryloxy and C₁-C₆-acyloxy, preferably OH, methoxy or ethoxy,

d is 3 to 6, preferably 4,

n is 0to 2 and

m is 2to 6,

and/or a (partial) condensation product thereof.

Such binders are described, for example, in U.S. Pat. No. 6,005,131 (specifically examples 6-9), WO 98/52992 (specifically examples 1-2) and EP-A 947 520 (specifically examples 1-9 and 11-14).

The conventional auxiliary substances in coating technology can optionally be added as components to the inorganic or organic coating or the inorganic-organic hybrid coating. Conventional auxiliary substances include all the additives known for the preparation of lacquers and paints, such as e.g. inorganic and/or organic pigments, light stabilizers, paint additives, such as dispersing agents, flow control agents, thickeners, defoamers and other auxiliary substances, adhesives, fungicides, bactericides, stabilizers or inhibitors. It is of course also possible to add several of the auxiliary substances mentioned.

The addition of light stabilizers is preferred if the polymeric substrate to be protected is light-sensitive as such. This is the case, for example, with polycarbonates. In this case, organic and/or inorganic light stabilizers are added to the inorganic coating in an amount necessary to protect the polycarbonate. Suitable organic light stabilizers are obtainable, for example, under the trade name Tinuvin UV absorber (Ciba Spezialitätenchemie GmbH, Lampertheim).

The present invention also relates a process for the production of the protective covering, characterized in that in a first step a two-component polyurethane adhesion promoter (primer) containing alkoxysilyl groups and in a second step an inorganic or organic coating or inorganic-organic hybrid coating is applied to a substrate, and a third coating is optionally applied thereto in a further step.

The third coating is particularly suitable for protective coverings which contain an organic or inorganic light stabilizer in the second coating, especially if high demands are made on the mechanical resistance of the substrate to be protected. This third coating can be a scratch- and abrasion-resistant or a hydrophobic/oleophobic coating, depending on the desired protective action. Inorganic coatings prepared according to the disclosure of EP-A 947 520 (specifically examples 1-9 and 11-14) are preferred as the third coating. This ensures that both the adhesion of the protective covering to the substrate and the protective covering as a whole are retained completely during weathering.

The coating build-up according to the invention can be applied to any desired substrates, such as, for example, polymeric substrates, such as polycarbonate, polymethyl methacrylate, ABS, polyamide or polyurethane, or also to polymeric blends, such as Bayblend (Bayer AG, Leverkusen) and Pocan (Bayer AG, Leverkusen), or to metals or also glass.

The substrates can also have, for example, organic coatings if an inorganic-organic hybrid coating or inorganic coating is to be applied to the substrate including coating.

While inorganic coatings which are distinguished by a very high abrasion resistance and scratch resistance and a very good resistance to solvents are preferably employed as the top layer, the coating build-up according to the invention is particularly suitable for providing abrasion- and scratch-sensitive substrates with a protective finish. Preferred substrates are thermoplastic polymers, such as polycarbonates, polymethyl methacrylates, polystyrene, polyvinylcyclohexane and copolymers thereof, acrylonitrile/butadiene/styrene copolymers or polyvinyl chloride or blends thereof. Transparent polymeric substrates are more preferred.

The application of the two-component polyurethane primer containing alkoxysilyl groups and of the inorganic or organic coating or the inorganic-organic hybrid coating is carried out by the conventional application processes in coating technology, such as e.g. spraying, flooding, dipping, spin-coating or knife coating.

If polymeric substrates are employed, curing of the wet paint films can be carried out, both for the primer and for the particular functional coating, between ambient temperature and the softening temperature of the polymeric substrate. For example, for polycarbonate as the substrate, the curing temperature range is preferably between 20° C. and 130° C. (Makrolon, Bayer AG, Leverkusen or Lexan, GE Plastics, USA) or 20 to 160° C. for Apec HT (Bayer AG, Leverkusen), at a curing time of between 1 minute and 60 minutes. Particularly preferably, the curing temperature range for Makrolon is between 100° C. and 130° C. and for Apec HT is between 100° C. and 160° C., at a curing time of between 30 and 60 minutes.

Wet-in-wet application is also possible, followed by a single curing in the abovementioned temperature and time interval.

For specific applications in which e.g. for technical reasons substrates of large area cannot be subjected to a curing in the temperature range and time interval according to the invention (e.g. house facade components, ship's hulls etc.), curing at ambient temperature may also be sufficient.

The invention also provides the use of the protective covering according to the invention for protecting the coated substrates against mechanical damage and/or radiation damage, such as UV radiation, and/or against contamination. Particularly sensitive substrates, such as polymeric substrates, in particular can thus be protected effectively.

The protective action of the protective covering, for example, a high mechanical resistance is retained completely even after intensive weathering. Thus, a polycarbonate sheet protected with the protective covering according to the invention against mechanical damage and UV light can be exposed to boiling, completely desalinated water for several days without a loss of adhesion or an optical change being detectable. After weathering for 1,000 hours in a UV-A test with an intensity of 1.35 W/m² (ASTM G 154-97, cycle 4), an optical change is to be observed neither on the substrate nor on the protective covering.

The protective covering according to the invention thus has an ideal combination of a very high protective action for the substrate coated according to the invention and a very good stability to weathering.

### EXAMPLES

In the examples described below, all the percentage data relate to the weight.

The paint additives used were Baysilone OL 17 (Bayer AG, Leverkusen), Tinuvin 292 (Ciba Spezialitätenchemie GmbH, Lampertheim) and/or Tinuvin 1130 (Ciba Spezialitatenchemie GmbH, Lampertheim).

### Example 1

N-(3-Trimethoxysilylpropyl)aspartic acid diethyl ester was prepared according to the disclosure of U.S. Pat. No. 5,364,955, example 5, by reaction of equimolar amounts of 3-aminopropyltriethoxysilane with diethyl maleate.

### Example 2

180 g (1 eq NCO) of a 100% HDI-isocyanurate with a viscosity of 1,200 mPas (23° C.) an average NCO content of 23% and an NCO functionality of 3.2 were initially introduced into a standard stirred apparatus. 17.55 g (0.05 mol) N-(3-trimethoxysilylpropyl)aspartic acid diethyl ester from example 1 were added dropwise at room temperature, with vigorous stirring, and the mixture was subsequently stirred for one hour. The resulting addition product had an NCO content of 20%.

### Examples 3 to 20

The same procedure as in example 2. Table 1 indicates the polyisocyanate and alkoxysilanes used in each case in the amounts employed in each case. The resulting NCO content of the addition product was stated in %.

Polyisocyanate A HDI-isocyanurate, 90% in butyl acetate with a viscosity of 600 mPas (23° C.), an average NCO content of 19.6%, an NCO functionality of 3.2.

Polyisocyanate B HDI-biuret, 75% in butyl acetate with a viscosity of 160 mPas (23° C.), an average NCO content of 16.5% and an NCO functionality of 3.8.

Polyisocyanate C IPDI-isocyanurate, 70% in butyl acetate with a viscosity of 700 mPas (23° C.), an average NCO content of 11.8% and an NCO functionality of 3.2.

Alkoxysilane 1: N-(3-Trimethoxysilylpropyl)aspartic acid diethyl ester from example 1

Alkoxysilane 2: N-Butyl-3-aminopropyltrimethoxysilane (Dynasilan 1189, Degussa-Hüls AG)

Alkoxysilane 3: Bis(trimethoxysilylpropyl)amine (Silques A-1 170, Wite)

Alkoxysilane 4: N-Methyl-3-aminopropyltrimethoxysilane (Dynasilan 1110, Degussa-Hüls AG)

Alkoxysilane 5: 3-Mercaptopropyltrimethoxysilane (Dynasilan NTNS, Degussa-Hüls AG)

TABLE 1
Examples 3 to 20

| | | | | | NCO | |
|---|---|---|---|---|---|---|
| | Polyiso- | Weight | Alkoxy- | Weight | content | Comments |
| Example | cyanate | [g] | silane | [g] | [%] | *¹ |
| 3 | A | 216 | 1 | 17.55 | 17.1 | — |
| 4 | B | 255 | 1 | 17.55 | 14.7 | — |
| 5 | C | 178 | 1 | 8.78 | 10.7 | — |
| 6 | B | 50 | 1 | 0.7 | 16.1 | — |
| 7 | B | 50 | 1 | 13.8 | 10.3 | — |
| 8 | B | 100 | 5 | 4.7 | 14.9 | |
| 9 | B | 100 | 5 | 9.4 | 13.5 | |
| 10 | B | 100 | 5 | 18.7 | 11.1 | |
| 11 | B | 100 | 5 | 46.7 | 5.9 | 60% in |
| | | | | | | BA |
| 12 | C | 100 | 2 | 3.29 | 10.8 | |
| 13 | C | 100 | 2 | 6.5 | 9.8 | |
| 14 | C | 100 | 2 | 13.1 | 8.3 | |
| 15 | C | 100 | 2 | 32.6 | 3.5 | 60% in |
| | | | | | | BA |
| 16 | B | 50 | 2 | 2.3 | 14.9 | |
| 17 | B | 50 | 4 | 1.89 | 15.0 | |
| 18 | B | 100 | 3 | 6.69 | 14.7 | |
| 19 | C | 100 | 5 | 3.34 | 10.8 | |
| 20 | B | 100 | 1 | 103.23 | 1.8 | 70% in |
| | | | | | | BA |

*¹SC: solids content in wt.%, BA: butyl acetate

Polyols and auxiliary substances suitable for the 2K PU binders used according to the invention were summarized in table 2. Components B1 to B5 were prepared by bringing together of the individual components listed in table 2 in any desired sequence and subsequent thorough mixing at room temperature.

Polyol 1: Trimethylolpropane

Polyol 2: Desmophen 670 (Bayer AG, Leverkusen) which represents a slightly branched polyester containing hydroxyl groups, 80% in BA with a hydroxyl content of 3.5%, an acid number of 2 mg KOH/g and a viscosity of 2,800 mPas (23° C.)

Polyol 3: Desmophen 800 (Bayer AG, Leverkusen) which represents a highly branched polyester containing hydroxyl groups, solvent-free with a hydroxyl content of 8.6%, an acid number of 4 mg KOH/g and a viscosity of 850 mPas (23° C., 70% MPA)

Polyol 4: Desmophen VPLS 2449/1 (Bayer AG, Leverkusen) which represents a branched, short-chain polyester, solvent-free with a hydroxyl content of 16%, an acid number of 2 mg KOH/g and a viscosity of 1,900 mPas (23° C.)

DAA: Diacetone alcohol

TABLE 2
Polyols and auxiliary substances (according to the invention)

| | B1 | | B2 | | B3 | | B4 | | B5 | |
|---|---|---|---|---|---|---|---|---|---|---|
| Polyol (X) | 12.3 | g (1) | 15.4 | g (2) | 11.6 | g (2) | 3.9 | g (2) | 12.3 | g (4) |
| X = 1,2,3,4 | | | | | 3.1 | g (3) | 9.2 | g (3) | | |
| Butyl acetate | 3.1 | g | — | | 0.8 | g | 2.3 | g | 3.1 | g |
| Baysilone ® | 0.2 | g | 0.2 | g | 0.2 | g | 0.2 | g | 0.2 | g |
| OL | | | | | | | | | | |
| 17 | | | | | | | | | | |
| 10% in DAA | | | | | | | | | | |
| Tinuvin ® 292 | 2.0 | g | 2.0 | g | 2.0 | g | 2.0 | g | 2.0 | g |
| 10% in DAA | | | | | | | | | | |
| Tinuvin 1130 | 2.0 | g | 2.0 | g | 2.0 | g | 2.0 | g | 2.0 | g |
| 10% in DAA | | | | | | | | | | |
| Zinc octoate | 0.4 | g | 0.4 | g | 0.4 | g | 0.4 | g | 0.4 | g |
| 10% in DAA | | | | | | | | | | |
| DAA | 170.5 | g | 170.5 | g | 170.5 | g | 170.5 | g | 170.5 | g |
| Equivalent | 692.0 | g | 6,012.0 | g | 4,835.0 | g | 3,521.0 | g | 1,639.0 | g |
| weight | | | | | | | | | | |

Preparation of the Adhesion Promoter (Primer)

A silicon-modified polyisocyanate from table 1 was brought together with one of the polyol mixtures A1 to A5 from table 2 at room temperature, in each case in an NCO:OH ratio of 1.2:1, and the components were mixed. The adhesion promoter according to the invention was ready for application. Corresponding combinations of polyol mixtures A1 to A5 and the silicon-modified polyisocyanates from table 1 were possible. Table 3 contains, by way of example, all the combination possibilities resulting from table 1 and table 2 for the preparation of the adhesion promoters (primers).

TABLE 3
Adhesion promoters (primers)

| | Polyisocyanate | | | |
|---|---|---|---|---|
| | from | | Polyol | |
| Example | example | Weight [g] | component | Weight [g] |
| 21 | 4 | 5.7 | A2 | 100 |
| 22 | 8 | 48.9 | A1 | 100 |
| 23 | 13 | 8.47 | A2 | 100 |
| 24 | 14 | 37.3 | A5 | 100 |
| 25 | 15 | 30.1 | A3 | 100 |
| 26 | 18 | 21 | A5 | 100 |
| 27 | 12 | 13.2 | A4 | 100 |

### USE EXAMPLES

The effectiveness of the protective covering according to the invention was demonstrated with the aid of the following examples.

Adhesion Properties of the Adhesion Promoters (Primers) According to the Invention on Polycarbonate

### Example 28

The previously prepared primer according to example 21 in table 3 was spin-coated in a layer thickness of approx. 0.1 μm on to a Makrolon sheet and cured for 60 minutes at 130° C. An inorganic coating was then spin-coated on in a layer thickness of approx. 3 μm and cured for 60 minutes at 130° C. Raw materials from examples 4 and 12 from EP-A 0 947 520 were employed for preparation of the organically modified inorganic coating. The procedure for this was as follows:

8.4 g D4-diethoxide, 15.9 g tetraethoxysilane and 19.9 g 1-methoxy-2-propanol were initially introduced into a flask and mixed. 2.0 g 0.1 N p-toluenesulfonic acid were then added at room temperature and the components were stirred for 30 minutes, before a further 2.0 g 0.1 N p-toluenesulfonic acid were added and the mixture was stirred for a further 60 minutes (pre-hydrolysate). In parallel with this, 4.8 g aluminium sec-butylate were dissolved in 1.5 g 1-methoxy-2-propanol in another flask and 2.5 g acetoacetic ester were added, while cooling with ice. The aluminium complex prepared in this way was added to the pre-hydrolysate at room temperature and a further 2.9 g 0.1 N p-toluenesulfonic acid were added. After a stirring time of 30 minutes, the coating solution was ready for application.

### Example 29

The same procedure as in example 28. However, the adhesion promoter according to the invention from example 23 (see table 3) was spin-coated on in a layer thickness of approx. 0.1 μm. Furthermore, instead of the inorganic coating described in example 28, the following paint was applied analogously:

29.5 g aluminum sec-butylate were first dissolved in 5.9 g 1-methoxy-2-propanol and complexed with 15.6 g acetoacetic ester at room temperature. This solution was then heated to 40 to 80° C. and, finally, 17.3 g D4-silanol (EP-A 0 947 510), dissolved in 31.8 g 1-methoxy-2-propanol, were added with constant stirring (aluminium/D4-silanol precursor). In parallel with this, 58.0 g tetraethoxysilane (TEOS) were dissolved in 50.3 g n-butanol, 5.0 g 0.1 N p-toluenesulfonic acid were added and the mixture was stirred for one hour at room temperature (pre-hydrolysate). Thereafter, the pre-hydrolysate was mixed, while stirring, with the aluminium/D4-silanol precursor, which had been cooled to room temperature, and the solution was stirred for a further hour. 105.9 g zinc oxide nano-dispersion (30 wt. % ZnO), 5.0 g p-toluenesulfonic acid (0.1 N) or 5.0 g demineralized H₂O and 58.9 g D4-silanol as a 35% solution in 1-methoxy-2-propanol were then added and the reaction mixture was stirred for a further hour at room temperature.

The zinc oxide nano-dispersion was prepared as follows: 590 g zinc acetate dihydrate were stirred in 2,000 g methanol (MeOH), analytical grade, in a 6 l flask at room temperature. The zinc acetate did not dissolve completely. In parallel with this, a potassium hydroxide solution (KOH solution) was prepared from 296.1 g KOH, analytical grade (86.6%), in 1,000 g MeOH, analytical grade, while cooling. 100 ml of the KOH solution were now added to the zinc acetate solution. The previously undissolved portion of the zinc acetate thereby dissolved. The remainder of the KOH solution was then added all at once. A voluminous, white precipitate formed immediately, and became translucent after a stirring time of about 70 min. The sol was now heated at the boiling point for 25 min and the heat source was then switched off. After standing overnight, a white sediment had formed. After stirring up, the sediment was centrifuged off (30 min, 5,000 rpm). 295.9 g of a gelatinous residue were obtained, analysis of which by X-ray diffractometry showed zinc oxide as a single crystalline phase. 439.3 g methylene chloride were added to the gelatinous residue and the mixture was shaken until the sediment had dispersed completely.

### Comparison Example 1

The same procedure as in example 28. 3-Aminopropyltrimethoxysilane, a primer for polycarbonate known from the prior art, was employed as the adhesion promoter and was spin-coated on in a layer thickness of approx. 0.1 μm.

### Comparison Example 2

The same procedure as in example 29. 3-Aminopropyltrimethoxysilane was spin-coated on as the adhesion promoter in a layer thickness of approx. 0.1 μm.

### Comparison Example 3

The same procedure as in example 28. Instead of the primer, a polyisocyanate which was not silicon-modified was employed as a crosslinking agent. For this, 100 g of polyol component A 2 from table 2 were stirred (in an NCO:OH ratio of 1.2:1) with 7.2 g of a 70% solution in butyl acetate of an IPDI-isocyanurate with an average NCO content of 11.8% and an NCO functionality of 3.2 and a viscosity of 700 mPas (23° C.) and the mixture was spin-coated on in a layer thickness of approx. 0.1 μm.

### Comparison Example 4

The same procedure as in example 29. Instead of the primer, a polyisocyanate which was not silicon-modified was employed as a crosslinking agent. For this, 100 g of polyol component A 2 from table 2 were stirred (in an NCO:OH ratio of 1.2:1) with 7.2 g of a 70% solution in butyl acetate of an IPDI-isocyanurate with an average NCO content of 11.8% and an NCO functionality of 3.2 and a viscosity of 700 mPas (23° C.) and the mixture was spin-coated on in a layer thickness of approx. 0.1 μm.

### Comparison Example 5

The same procedure as in example 28. Instead of the primer, a polyisocyanate which was not silicon-modified was employed as a crosslinking agent. For this, 100 g of polyol component A 2 from table 2 were stirred (in an NCO:OH ratio of 1.2:1) with 5.1 g of a 75% solution in butyl acetate of an HDI-biuret with an average NCO content of 16.5% and an NCO functionality of 3.8 and a viscosity of 160 mPas (23° C.) and the mixture was spin-coated on in a layer thickness of approx. 0.1 μm.

### Comparison Example 6

The same procedure as in example 29. Instead of the primer, a polyisocyanate which was not silicon-modified was employed as a crosslinking agent. For this, 100 g of polyol component A 2 from table 2 were stirred (in an NCO:OH ratio of 1.2:1) with 5.1 g of a 75% solution in butyl acetate of an HDI-biuret with an average NCO content of 16.5% and an NCO functionality of 3.8 and a viscosity of 160 mPas (23° C.) and the mixture was spin-coated on in a layer thickness of approx. 0.1 μm.

The Makrolon sheets coated according to examples 28 and 29 and mparison examples 1 to 6 were exposed to weathering and then checked for adhesion. For this, in each case one sheet was stored in mineralized water for 8 hours at 100° C. A further specimen was stored in demineralized water for 14 days at 65° C. Furthermore, in each case one sheet was exposed to weathering for 1,000 h in accordance with ASTM G 154-97 cycle 4. After the weathering, the adhesion was tested by means of the cross-hatching of DIN EN ISO 2409. The results of the cross-hatch testing after weathering were summarized in table 4.

TABLE 4
Cross-hatching according to DIN EN ISO 2409 after weathering

| | | Adhesion after | Adhesion after | Adhesion after |
|---|---|---|---|---|
| | | storage in | storage in | weathering for |
| | | demineralized | demineralized | 1,000 h accord- |
| | Base | water for 8 h | water for 14 h | ing to ASTM G |
| | adhesion | at 100° C. | at 65° C. | 154-97 cycle 4 |
| Example | | | | |
| 28 | 0 | 0 | 0 | — |
| 29 | 0 | 0 | 0 | 0 |
| Comp. | | | | |
| examples | | | | |
| 1 | 0 | 5 | 5 | — |
| 2 | 0 | 5 | 5 | 5 |
| 3 | 5 | — | — | — |
| 4 | 5 | — | — | — |
| 5 | 0 | 5 | 5 | — |
| 6 | 0 | 5 | 5 | 5 |

Cross-hatching Characteristic Value:

no detachment at all: (0)

complete detachment: (5)

not carried out: (---)

TABLE 5
Taber values

| | Example | Comparison | Uncoated |
|---|---|---|---|
| | 28 | example 5 | Makrolon sheet |
| Increase in scattered light | 10% | 50% | 54% |
| (Δ haze) according to ASTM | | | |
| D 1002 after scratching | | | |
| according to ISO 3537, 500 g | | | |
| per wheel, CS10F stones, | | | |
| 1,000 cycles | | | |

Tables 4 and 5 demonstrate the effectiveness of the protective covering according to the invention. Polymeric substrates, such as e.g. polycarbonate, could be effectively protected against environmental influences and against mechanical damage. The comparison examples either showed a lower stability to weathering and/or offer a lower protection against mechanical damage.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A protective covering comprising at least a two-layer coating build-up wherein
the first coating comprises a two-component polyurethane adhesion promoter (primer) containing alkoxysilyl groups and
the second coating comprises an inorganic or organic coating or an inorganic-organic hybrid coating.

2. The protective covering of claim 1 wherein the two-component polyurethane adhesion promoter comprises
I)
a hardener component (A), comprising an addition product of at least one organic polyisocyanate (B) with an average NCO functionality of 2.5 to 5.0 and an isocyanate content of 8 to 27 wt. % and
an alkoxysilane (C) with at least one group which is reactive towards isocyanate groups, of formula (I)
Q—Z—SiXₐY₃₋ₐ (I),
in which
Q represents an isocyanate-reactive group,
Z represents a linear or branched C₁-C₁₂-alkylene group,
X represents a hydrolyzable group,
Y represents identical or different C₁-C₄-alkyl groups, and
a represents an integer from 1 to 3,
and
II) a paint resin (D) which is reactive towards isocyanate groups.

3. The protective covering of claim 2 wherein
Q represents OH, SH or NHR₁, wherein R₁ represents a C₁-C₁₂-alkyl group, a C₆-C₂₀-aryl group or —Z—SiXₐY₃₋ₐ,

4. The protective covering of claim 2 wherein
Z represents a linear or branched C₁-C₄-alkylene group,

5. The protective covering of claim 2 wherein
X represents a C₁-C₄-alkoxy,

6. The protective covering of claim 1 wherein the second coating comprises an inorganic coating.

7. The protective covering of claim 1 wherein the second coating comprises an organically modified inorganic coating.

8. The protective covering of claim 7 wherein the organically modified coating comprises at least one multifunctional, cyclic carbosiloxane of the general formula (III) 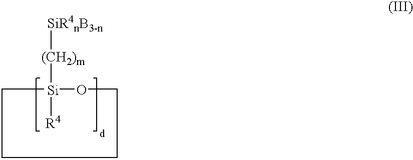
in which
R⁴ independently of one another represents a C₁-C₁₈-alkyl group and/or a C₆-C₂₀-aryl group, wherein
B represents a radical chosen from the group consisting of OH, C₁-C₄-alkoxy, C₆-C₂₀-aryloxy and C₁-C₆-acyloxy, preferably OH, methoxy or ethoxy,
n is 0 to 2 and
m is 2 to 6, and/or a (partial) condensation product thereof.

9. The protective covering of claim 8 wherein B represents OH, methoxy, or ethoxy.

10. A process for the production of a protective covering comprising applying in a first step a two-component polyurethane adhesion promoter (primer) containing alkoxysilyl groups and applying in a second step an inorganic or organic coating or inorganic-organic hybrid coating to a substrate.

11. The process of claim 10 further comprising applying in a further step a third coating on the substrate.

12. The process of claim 10 wherein the substrate comprises a metal, a glass, or a polymer.

13. The process of claim 10 wherein the substrate comprises polycarbonate, polymethyl methacrylate, polystyrene, polyvinyl chloride, polyvinylcyclohexane and copolymers thereof, polyimide, ABS or blends thereof.

14. A substrate comprising at least one protective covering of claim 1.
